(19) United States
(12) Patent Application Publication
(10) Pub. No.: US 2019/0136823 A1
(43) Pub. Date: May 9, 2019

(54) MODULAR LATTICE WAVE MOTION ENERGY CONVERSION APPARATUS

(71) Applicant: Matthew Laurence LEWIS, Brooklyn, NY (US)

(72) Inventor: Matthew Laurence LEWIS, Brooklyn, NY (US)

(21) Appl. No.: 16/237,237

(22) Filed: Dec. 31, 2018

Related U.S. Application Data
(63) Continuation-in-part of application No. 15/269,004, filed on Sep. 19, 2016.
(60) Provisional application No. 62/246,018, filed on Oct. 24, 2015.

(51) Int. Cl. F03B 13/20

(52) U.S. Cl. CPC F03B 13/20; F05B 2220/706

(57) ABSTRACT

An ocean wave energy collecting apparatus for extracting power comprises a plurality of modules in a lattice formation, moored as a group to the sea floor via tether(s), each module reacting to each adjacent module. Connecting members connecting the modules rotate about the points where the connecting members enter the modules in response to the orbital motion of water particles in ocean waves. A collection of modules is arranged and interconnected in crystal-like lattice layers, such that each module has rotation and/or linear motion in relation to an adjacent module as ocean wave energy passes, and is captured and converted to electricity, by the apparatus.

### CROSS-REFERENCE TO RELATED APPLICATION

This application is a continuation-in-part of U.S. patent application Ser. No. 15/269,004, filed Sep. 19, 2016, which claims the benefit of U.S. Provisional Patent Application No. 62/246,018, filed Oct. 24, 2015, both of which are incorporated by reference herein.

### BACKGROUND OF THE INVENTION

The present invention relates to an apparatus and method for converting ocean wave motion to electricity.

The potential of ocean wave energy as a stable, reliable source of electricity is enormous. It is estimated that total worldwide available ocean wave power is on the order of 1-10 TW. This lays bare an enormous opportunity, if the right wave power collection solution presents itself.

The energy available in a unique propagating ocean wave can be calculated from:

$$E = \frac{ρ {gH}^{ 2} L}{8}$$

### Where,

E=total energy in a wave per unit crest width
ρ=density of water
g=acceleration due to gravity
H=wave height
L=wave length
Thus, ocean wave energy is proportional to the square of wave height.

Wave energy is generated via wind, and solar energy. Thus wave energy is essentially a form of wind and solar energy. Unlike wind and solar energy, which is intermittent, and unpredictable, ocean wave energy is nearly consistent, and highly predictable. Potentially available at such enormous scales, it is a great reservoir of untapped energy looking for the proper solution to tap it.

Impediments to implementation of wave energy converters on the macro scale arise primarily due to survivability, and efficiency. Any ocean wave energy convertor must be able to survive in severe storm conditions, where rare rogue waves, and violent water motion, can have great destructive power.

Further, the device must be able to capture a maximum amount of wave energy available at any time and convert that into electricity.

Today's devices, surprisingly, allow great amounts of propagating ocean waves to flow past their devices, not fully realizing the capture potential and the density of energy available at any particular ocean area that is tapped for an energy resource. Furthermore, even at a particular location where a wave energy convertor sets out to capture energy, the total orbital motion available as an energy source at that location is not maximally absorbed, captured and converted. Typically only a decomposed arc of the motion, whether in the form of the to-and-fro component of the motion (surge), or the up-and-down component of the motion (heave), is captured. Issues with survivability of existing devices prevent confidence in investment needed to move these projects forward. A wave energy convertor must simultaneously be durable and efficient, capturing the maximum amount of the energy density available at any location.

Examples of apparatuses that have been proposed include U.S. Pat. No. 8,358,025 to Hogmoe, which is incorporated by reference, which discloses an array of buoyant bodies and at least one energy-generator connected to one or more moveable links and forming a part of each link.

U.S. Patent Application No. 2011/0304144, likewise incorporated by reference, teaches a device in which an array of members are connected together to form a structure having link members, nodes and absorbers, wherein the relative motion of at least some of the members of the array, is convertible to another form of energy.

U.S. Patent Application Publication No. 2011/0308244, likewise incorporated by reference, describes a layer of pods in a wave motion energy conversion apparatus, arranged in such a way as to leverage the vertical heave of the waves.

U.S. Pat. No. 4,098,084 to Cockerell, which is incorporated by reference, teaches a wave energy capture apparatus including a plurality of buoyant members which are interconnected one with another so as to be movable relative to one another, each buoyant member being provided with a plate or plate-like member which is supported from the buoyant member.

U.S. Pat. No. 4,672,222 to Ames, also incorporated by reference, teaches an apparatus for converting the energy of wave motion on the surface of a body of water to electricity.

U.S. Patent Application Publication No. 2010/0213710 to Rhinefrank, also incorporated by reference, teaches an apparatus and method for converting wave energy using the relative rotational movement between two interconnected float assemblies and the relative rotational movement between each of the float assemblies and a spar which extends from a connection with the float assemblies at the water surface into the water.

U.S. Pat. No. 7,245,041 to Olson, also incorporated by reference, teaches a device including a long cylinder shaped beam submerged in the ocean and suspended horizontally by multiple floats for converting ocean wave energy.

None of the foregoing prior art devices takes advantage of the full orbital motion of ocean waves using a multi-layer lattice structure constructed of individual nodules and connecting members.

### SUMMARY OF THE INVENTION

In one aspect, the invention is an apparatus for extracting power from wave motion in seawater over a sea floor, comprising: a lattice structure comprised of a plurality of modules, said plurality of modules arranged into a plurality of layers, including an upper layer of modules and a lower layer of modules, said upper layer of modules being buoyant and said lower layer of modules being negatively buoyant in said seawater, each module being attached to at least one module vertically and at least one module horizontally to form the lattice structure; and a plurality of connecting members, each said connecting member attached to at least two vertically adjacent modules at respective connection points, and adapted for rotation at each said respective connection point (i.e., rotational motion of the connecting members at the connection point). A mooring anchor is attached to the sea floor and a tether is attached between the anchor and the lattice structure. A plurality of motion transducers, each within a respective module, is adapted to convert the rotational motion of the connecting members relative to said modules to electrical energy.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts a three-dimensional lattice structure tethered to the sea floor at one location, the interconnected lattice structure curving in reaction to the waves; in this embodiment, the tether is connected to the entire array at two locations along the lower layer of modules;

FIG. 2 depicts a profile of a two-level, three-dimensional lattice structure of the device illustrating a chain-of-parallelograms effect, folding at respective corner joints of the parallelograms in reaction to the orbital motion of the waves; wherein the entire structure is tethered to the sea floor, including a representation of a spring, or spring-like, element within or on the tether line, according to an embodiment of the invention;

FIG. 3 depicts a close up of a two-level three-dimensional lattice structure, illustrating both the horizontal and vertical connections;

FIG. 4 depicts a three-level realization of the three-dimensional lattice structure. where the arrangement of modules parallels that of an FCC (face centered cubic) structure, with rotating joints at each connection point to allow for the collapsing chain of parallelograms to follow the circular motion of the ocean waves;

FIG. 5 depicts a three-level representation of the device in a three-dimensional interconnected lattice structure, where the arrangement of modules parallels a BCC (body centered cubic) configuration, as an example of alternative structure, whereby parallelograms formed by the vertical and horizontal interconnectedness of the multi-level structure conform to and follow the circular orbital path of ocean wave motion;

FIG. 6 depicts the orbital motion of a wave as the wave proceeds from trough to crest and back to trough through intermediate stages;

FIG. 7 shows the position of an apparatus according to the invention at the different position of a wave's orbital motion depicted in FIG. 6;

FIG. 8A and FIG. 8B depict connection members connecting modules;

FIG. 8C and FIG. 8D depict connection members with telescoping sections adapted to be collapsed or lengthened;

FIG. 9A and FIG. 9B depict modules according to embodiments of the invention; and

FIG. 10 depicts an apparatus according to an embodiment of the invention having a lower layer of modules with differently shaped modules.

The drawings are schematic and not to scale.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A wave energy convertor according to embodiments of the invention utilizes both the strength of a three-dimensional crystal-like lattice configuration, and the ability of the lattice configuration to maximize energy extraction by allowing relative rotational and/or linear motion at each lattice connection point. In addition, or alternatively, motion within the connecting member itself may be leveraged to capture energy. A variety of crystalline-like configurations can be used as the operating structure, utilizing the energy capture method described. By having two or more layers of interconnected energy-capturing modules, with the lower-most layer moored to the seabed by a tether attached to the front-most modules of that layer, closest to the oncoming, incident waves (creating a “reaction” layer, limiting the complete surge, heave and therefore mass displacement of the lower layer(s), while still moving in synchrony, with an upper layer, and also allowing the entire connected lattice to swivel into the direction of the oncoming incident waves, facing the energy producing wave fronts), a maximum amount of the orbital water particle motion in an ocean wave can be captured.

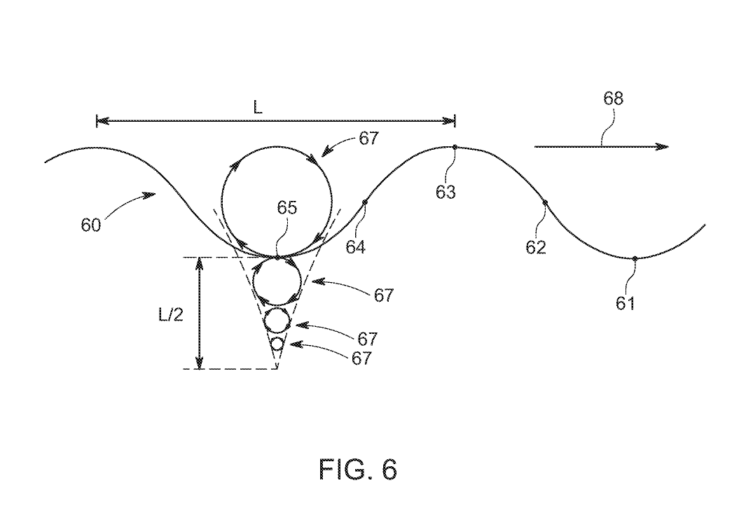

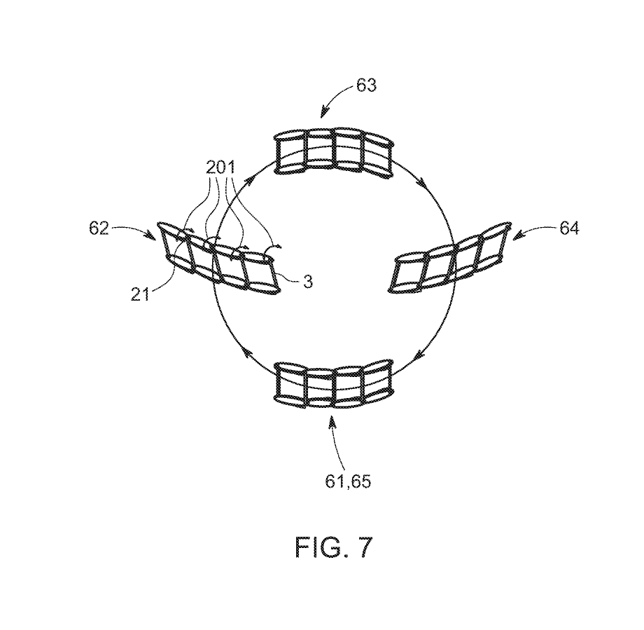

Wave orbital motion can be decomposed into heaving (vertical, z-direction) and surging (wave direction, x-direction) motions. FIG. 6 depicts the orbital motion of a wave 60 moving in the direction of arrow 68 over period L as it moves from trough 65 to crest 63 to trough 61 through intermediate stages 62, 64. The corresponding position of the apparatus at each position in the orbital motion of the wave is depicted in FIG. 7. This shows the orbital motion converted to a rotational motion 201 of the connecting members 3 around connection points 21. In embodiments, the end of a connecting member 3 inside a module may drive the shaft (or may be the shaft) of a conventional induction motor. The rotational motion of the shaft is back and forth about the connection point, in directions clockwise and counter-clockwise, and may be captured in a conventional induction motor with appropriate gearing, as is well understood in the art. Other motion transducers are likewise known in the art.

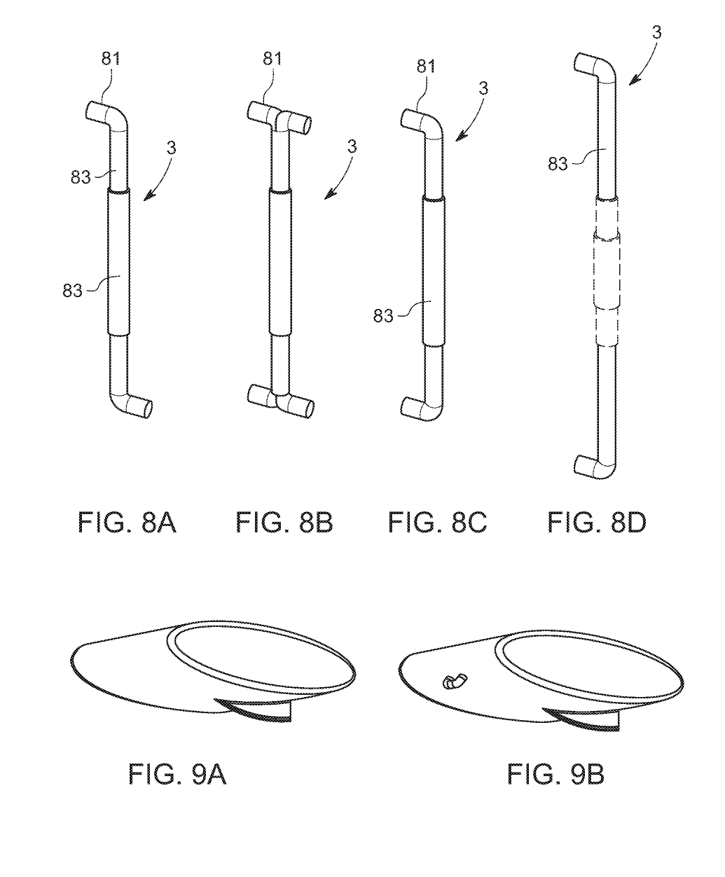

FIGS. 8A through 8D depict connecting members 3 according to embodiments of the invention. Ends 81 of connecting members 3 may extend at a 90 degree angle from a main section 83 to be operatively connected to connection points 21 on the modules 1. Sections 83 between ends 81 maintain a distance between layers of modules. In embodiments, shown in FIGS. 8C and 8D, sections 83 may be made up of a plurality of concentric subsections adapted to collapse and extend in “telescope” fashion. The overall length of section 83, including all subsections is determined by the desired distance between layers, typically some fraction of wave period L less than L/2, such as L/3, L/4, L/5, L/6, etc., or some intermediate value, which may be left to the person of ordinary skill to select. In this way the distance between layers of modules may be increased or decreased according to wave height or distance may remain fixed.

Non-limiting examples of modules are depicted in FIGS. 9A and 9B. Modules 91 are generally hollow and water-tight so that they can float and house an induction motor or other transducer operatively connected to a connecting member 3. In embodiments, modules may be provided with vanes 93 to assist the floating module orienting itself in the direction of an incident wave. A fastener 95 may be used to attach a tether to one or more modules in the top layer, the bottom layer or both. The modules of the bottom layer are negatively buoyant, having a mass of 1.2 to 1.5 times the mass of water occupying the same volume of the module.

The magnitude of the orbital motion 67 decreases exponentially with increasing depth, with no effective orbital motion at a depth equal to one half of the current wavelength L. A lower layer, as opposed to upper layer, that is tethered provides for a greater capture of the orbital motion at the ocean surface, allowing less restricted. movement at the water surface where the diameter of orbital motion is at its maximum size. At each of the connection points 21 where a connecting member 3 is attached to a module, there is the individual ability to capture rotational motion which can be converted into usable energy. Each joint can utilize a universal joint, or constant velocity joint, or like device with up to three degrees of rotational freedom, allowing transverse ocean waves (producing “roll” in modules) to pass by/through the apparatus without affecting capture of wave energy via “pitch” of modules. “Yaw” is primarily facilitated via alignment of the entire structure to face (incident) waves, though it may also be facilitated at module joints. These joints allow for any changes in angles of the incident waves, due to transverse waves present or other motion influences, to continuously be decomposed into their constituent rotational elements and those elements on the generators axes then to be translated into consistent rotational motion 201, and thus capture the primary energy available. These rotational motions can then be converted to electricity, via generators within each module, that is then sent back to shore for storage, or transmission, via transmission cables, or optionally stored at sea before transmission. The following coordinate system may be used: Pitch (around y) is the primary rotational motion of the modules induced by the motion of the ocean waves, creating the rotational movement that is converted to energy. The universal, or universal-like joints, allow for roll (around x) at connection points. Yaw (around z) is primarily accomplished via underwater mooring of the total lattice wave farm to the seabed (as described above), allowing the entire lattice structure to turn, and swivel, to face the structure in the direction of the oncoming waves, and additionally at each joint for complete freedom of movement, and alignment, with weathervane-like guides beneath each module, aiding in this direction finding.

As each wave passes an element, such as a surface module, the module moves toward the oncoming wave from its trough, lifting up with the increasing height, and riding the top of the wave in the direction of the wave motion, before returning again, and repeating its orbit. This motion was once thought to include no net translational motion, such that any object at sea would theoretically stay in one location, orbiting endlessly in relation to oncoming waves. It has since been found that there is indeed some net translational motion, known as mass transport. This net displacement is also known as Stokes drift, and can be calculated. Thus, orbits return from their path but at a small progression forward with the wave. This mass transport aids in keeping the lower tethered layer of the wave farm taut via the tether in relation to the mooring anchor, and aids in it being a steady reaction element to the upper layer, with primarily only the ability to surge back toward the oncoming waves a shorter distance than would otherwise be expected without mass transport, and heave upward, all at exponentially smaller radii than the orbits of the paths of the above layer(s). Thus, even at this surge portion of a motion arc, there is still a differential between upper and lower modules of distance travelled, greater than would otherwise be expected by orbital size, in horizontal surge, as the orbit returns toward the incident approaching waves. In addition, the fact that the lower layer of modules is negatively buoyant, and more massive than the buoyant upper layer of modules from which the lower layer is suspended, the principle of conservation of momentum comes into play. Modules of the lower layer, being more massive than modules of the upper layer, experience less change in velocity in comparison to the lighter modules of the upper layer. Therefore, the upper layer of modules will more readily move in conjunction with the orbital motion of the wave, compared to the lower layer of modules which will accelerate at a slower rate in reaction to that orbital motion. This effect is combined with the smaller orbit at lower depth to which the lower layer of modules is exposed to increase the differential motion between the two layers, adding more rotation to the system at the point where the connecting members enter the modules in relation to the position of the modules themselves. This design attribute of ours of having submerged, more massive modules suspended from buoyant modules greatly increases torque at the rotation points, further utilizing available wave energy to a greater degree than typical ocean wave converters. The portion of motion moving with the wave direction allows for full capture of that half of the surge (horizontal, x direction) component of the orbit because of the taut nature of the lower layer during this part of the circular/orbital cycle. As an upper layer surges in relation to a lower layer, rotation occurs via the joining connecting members, at each module's joints, complementing the contributed motion from the surface modules riding the waves themselves as the two, or more layers heave in synchrony. As an addition, another seabed mooring connected to the surface layer of modules (also allowing yaw, and swivel movement of the total lattice structure), with a tether allowing elongation, with a force to return it to initial length, may be useful in both preventing extreme angles between the aligned layer of surface modules in relation to the submerged layer(s), and in returning energy to the system made available during the mass transport effect via a restoration force. The heave (vertical, z direction) components of the orbital path travelled by water particles are captured in the rotation at the joints. As the modules ride over the oncoming waves, the apparatus takes on the shape of the wave, including rising and falling with the changing wave height, which creates a rotation of the connecting members about the respective connection points. The lack of buoyancy of lower layer(s) allows further resistance to these movements, allowing maximum torque potential for gear multiplying within each module. All rotational energy-generating motions can then be mechanically or electronically summed within each module, via ratcheting and/or other system, to fully utilize the maximum potential of available motion energies. For this purpose, more than one sea bed anchor may be used to advantage with the apparatus of the invention, and more than one tether, connected to more than one layer of the lattice structure, without departing from the scope of the invention.

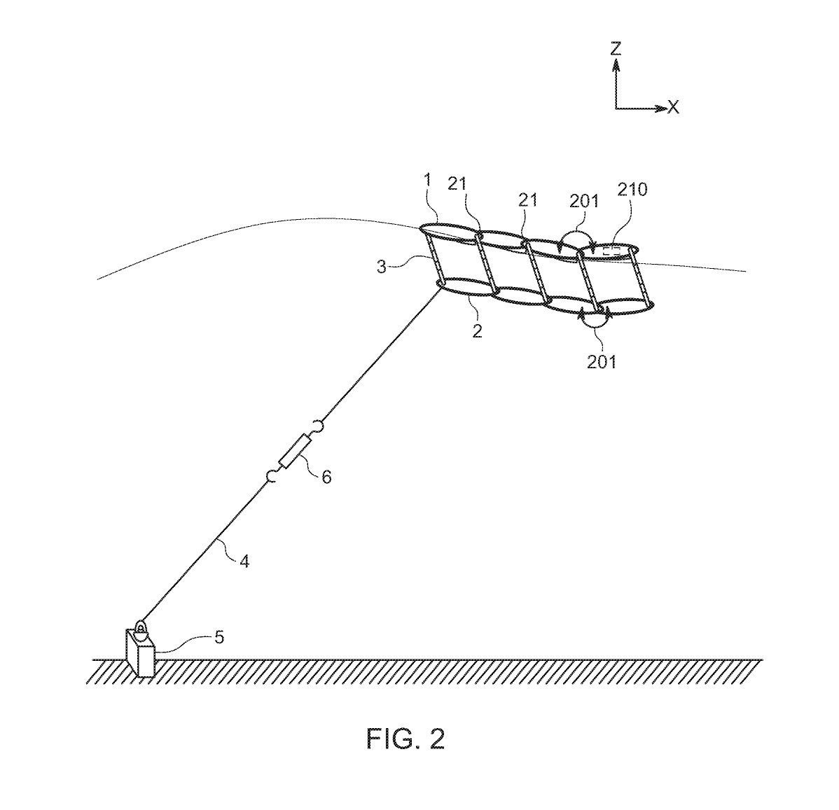

Application of the conventional x-y-z coordinates are depicted in FIG. 2. As described, z is the vertical axis, x is in the direction of the wave, and the y axis (not shown), in the direction of the paper, is a lateral direction with respect to an incident wave. In an x-z view an apparatus according to an embodiment of the invention can be seen as a chain of parallelograms with the respective upper and lower modules serving as the upper and lower parallel sides of each parallelogram, and the successive connecting members serving as the forward and aft parallel sides of each parallelogram in relation to oncoming waves. In the x-z view equal opposite angles are formed where each row of connecting members meets each corresponding row of modules. A parallel relationship is maintained between connecting members in the direction of an oncoming wave because of the lateral connection of modules to one another (for example using an “I” shaped connecting member as shown in FIG. 8B). Due to rigid lengths between connection points on each module, and set lengths of each connecting member, and the fact a single axis runs through a row of corresponding connection points receding in the y-axis direction ensures, throughout the structure, that a successive formation of parallelogram shapes is maintained in an x-z view throughout the device's range of motion, forming a consistent chain of parallelograms, each parallelogram sharing a connecting member as one of its forward and/or aft sides with its adjacent parallelogram formations, but free to form its own equal opposite angles according to wave conditions at that location in the device's path. The corners of each of these consecutive parallelograms are freely rotating joints rotating around the y axis that are not fixed but able to move freely in the x-z plane. Due to the inherent geometric limitation of movement this four-sided shape can take with jointed corners, the arc paths of a chain of four-sided parallelograms is circumscribed such that when positioned in the x-z plane in relation to oncoming waves in the x direction, the differential motion of the upper and lower layer of modules allows it to trace out a large proportion of the path of the orbital motion of a wave's water particles as it passes by, therefore maximally capturing the kinetic energy available in the ocean wave.

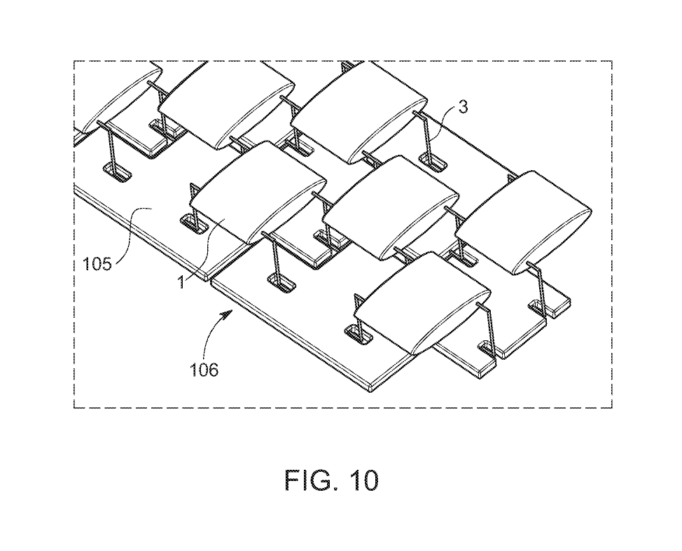

In embodiments, modules 105 of lower layer 106 may be shaped differently from modules 1 of the upper layer. In the embodiment depicted in FIG. 10, modules 105 of the lower layer are flatter with more rectangular edges. Also as shown in FIG. 10, the lower layer 106 of modules 105 may be configured to create an extended surface area in an x-y plane (also referred to as x-y view) compared to the corresponding surface area occupied by the upper layer. For example, viewed in plan view, the modified modules of the lower layer may occupy more than 80% of the area of the x-y plane, in embodiments more than 90% of the area, and in still other embodiments, almost 100% of the area of the x-y plane (as shown in FIG. 10), allowing only sufficient space between modules 105 to permit them to move independently. Configuring the lower layer 106 of modules in this way creates an articulated, suspended, submerged platform out of the lower layer of modules, mimicking the hydraulic properties of a natural oceanic shoal, such that wave height substantially increases as ocean waves pass over. When orbiting water particles touch the submerged surface of the lower layer, wave heights increase in amplitude, thus changing the wave into a form from which the energy in the wave is more concentrated in its physical waveform. Being that the square of wave height is directly proportional to the energy in a ocean wave, this increase in amplitude allows for a large increase in energy capture and therefore output of energy generated from our device, which rides over the now steeper physical wave. In this particular embodiment, the apparatus takes advantage of these increased wave heights because the upper modules ride over and fall down the surface of the waveform, utilizing the shoaling phenomenon. This unique approach to simultaneously inducing conditions that our device can then take advantage of is made possible by our inherent crystalline lattice structure, with its profile of chained parallelograms, allowing a modified form of lower layer modules to act as the articulated, virtually-hinged platform described above, always suspended a specific distance below the surface of the waves equal to the vertical lengths of the connecting members. One form of our device allows these connecting members to change length via telescoping in response to wave conditions and therefore form the articulated artificial shoal in such a way as to maximize electricity generation. Through a feedback system of information, sensing changing wave conditions and then responding by telescoping the connection members and thus positioning the depth of the said artificial shoal layer in such a way as to optimize the induced changes in wave heights, the device can maximize and concentrate energy available to then be extracted from an ocean wave. This shoaling effect is a well documented physical principle, with many studies published demonstrating the advantages of increasing wave heights to increase the readily available energy to be captured in an ocean wave. The device according to embodiments of the invention is able to uniquely take advantage of the shoaling principle because of the more massive, less buoyant lower layer of suspended modules. Embodiments of the device having an articulated shoaling platform may utilize only a bottom layer having an extended surface area in the x-y plane. For example, where the lattice structure has only two layers, the bottom layer may have modules with extended surface area compared to the upper layer. Where the lattice structure has a lower layer and a plurality of upper layers, the bottom layer may have modules with extended surface area compared to each of the upper layers. In the embodiment of FIG. 10, the shapes of the modules are assembled in a mating configuration to form a substantially continuous articulated plane.

As shown in FIGS. 8C and 8D, telescoping connecting members 301 as opposed to completely rigid connecting members also may be utilized. For example, in embodiments, the connecting members may be provided with several sections of varying diameters, each concentric to the other and water tight in relation to each other, configured to collapse, or “telescope,” into each other in order to change the vertical distance between the upper and lower layer of modules. The connection points where the connecting members connect to the modules operate as described above to capture motion. The telescoping connecting elements' motion between lattice layers can be calibrated in real time for optimum operating range, in relation to wave conditions, to allow for adaption to various wave heights or other oceanographic or atmospheric conditions, present via feedback sensors, or remote commands sent to the wave farm itself (picked up by receivers located with transmitters on the modules themselves), or be preset according to wave field typical conditions. The apparatus could also retract these telescoping members to allow for greater durability during extremely rough, and destructive conditions, if necessary, to improve the longevity and preserve the strength of the apparatus. In embodiments, the length of the connecting members is are not set, but rather may calibrate to the most efficient energy-generating length and operating range and may be modified to achieve maximum energy absorption of energy in circular ocean wave orbits by matching the greatest displacement of the circular orbital arcs available that is possible. The optimal distance between layers is set to take advantage of the limited depth of orbital motion in an ocean wave, which disappears at a depth equal to one half of the length of the wave.

The growing need for ocean wave mitigation solutions, for coastal municipalities and communities requires new, original ideas and solutions. Baked into the very design of this crystal-like lattice structure wave energy converter is the resiliency required to survive extreme ocean wave conditions. The device has an inherent three-dimensional interconnectivity, and density of spacing within the apparatus, across potentially large ocean areas that allows it to ideally function as a wave dampening solution to lessen the magnitude of destructive forces encountered during extreme weather conditions, while at the same time capturing the energy the apparatus is dissipating from the waves Groupings of offset arrays of lattice structure configurations of modules, allows for a multilayered, multi-stage reduction of wave energy as the waves reach each spaced-apart array of modules, thereby down-stepping the energy in multiple stages in order to both capture as much energy as possible from the waves' motion, and by doing so deplete and reduce the energy content of the waves and their ability to cause destruction at the shoreline.

The apparatus includes a motion transducer adapted to convert rotational motion of the connecting members relative to the modules to electrical energy. There are typically two ways to convert the motion of the ocean waves, when captured, into power. One involves utilizing the rotation that is harvested in an induction generator directly, whereby electricity is produced via an arrangement of magnets in the generator in which a relative motion is produced between the magnets in relation to the electrical wiring current path in the generator, this all facilitated via the rotational motion directly captured by the device. An element operatively connected to a rotating member maybe a rotating member in a conventional induction motor. Because rotation of connection members 3 about connection points 21 is typically two-way in direction when capturing oscillating ocean waves, a form of gearing is often utilized such that it turns the two-way rotation captured into one-way motion before entering the generator. Generators may also be “coded” in the arrangement of the magnets and wiring, meaning it utilizes a unique relative wiring-magnet arrangement, such that one-way direct current electrical current output is created despite the two-way rotational input. Another electronic means for creating a one-way direct current output can be achieved via electronic circuitry means, such as with a bridge-rectifier circuit design, whereby alternating current input into the circuit is converted to direct current output. This allows the two-way alternating electrical current output of a generator, created from a two-way rotational motion input, to be converted to direct current electricity after the electrical induction generation in the electricity-creating chain. Hydraulic means are another typical method for utilizing the energy captured in an ocean wave and changing it into usable electricity. Rotational motion captured by the wave energy converter device can be utilized to increase pressure in a fluid such that it drives a turbine, which then drives a generator. Each rotation connection point between a module and a connecting member within an array of modules will have its own generator within said respective module, or gearing may be utilized to mechanically sum the motion of all rotation points within a module, to feed one singular generator per module, or any variety of configuration thereof within a module. Any of the above listed methods may be utilized with an apparatus according to the invention to convert the motion and energy captured into a usable, transmittable form of electricity.

In embodiments, means are provided, such as an electrical cable, to carry captured electricity from the apparatus to land. Once electricity is electronically summed between energy generating modules, via interconnected electrical wiring between modules, a single output electrical line will emerge from each array, or subset of modules within an array, and be sent and transmitted via undersea cable to land for its utilization, or to a storage outpost at sea, which may be located at the energy generation site. These undersea cables lay across the sea floor to send electricity back to shore utilizing established marine technology for the laying of undersea cable and the maintenance thereof.

As shown in FIG. 6 and FIG. 7, there is a relative motion between the connecting members 3 and the modules 1 about connection points 21 that the connecting members interconnect. A generator, fixed in relation to a module, contained inside module, is able to capture this relative motion, inputted as rotation along the y axis from the relative motion of the connecting members to the modules at the insertion point of the connecting members into the modules. The ends of these connecting members, running along the same y-axis, serve as extensions to the generator drive shafts when entering the module. Coupled to the end of the inserted connecting member there may be a gearbox, also located within the respective module, which multiplies rotation speed (angular velocity), which is then coupled to a generator shaft along the same axis as the end of the respective connecting member at the insertion point into the module. In the case of an induction generator, for example, as the shaft rotates within the generator device, driven by the relative rotation of the connecting member to the module body, electrical wire windings fixed and attached to the shaft, located on what is called the rotor, move in relation to magnets that are fixed in place on the generator's chassis at a location called the stator; or, respectively, electrical windings fixed on the stator, move in relation to magnets fixed and attached directly to the aforementioned rotor. These connecting members are allowed to rotate freely at their connection points to respective modules in either direction along the y-axis in response to the differential movement of the upper and lower layers of modules in relation to each other. Therefore, the generator shaft, in synchronous motion with the respective connecting member, may receive two-way oscillatory inputted motion, and gearing may be provided which rectifies two-way rotation to one-way rotation. It is this initial, oscillating two-way motion, induced by the movement of the two layers' (upper and lower) over and beneath the ocean waves respectively, that perpetuates this continuous oscillation that serves as the origin of the input rotation motion to the generators contained within each module. An induction motor is a commercially available item and the selection and configuration of an induction motor may be left to the skill of the artisan and this disclosure is not to be deemed limiting of the general concept of a “motion transducer”.

The one or more tether attaching the apparatus to the sea floor may be provided with a linear and/or nonlinear spring element. Although a linear spring is schematically depicted in the figures in combination with the tether, other options and technologies may be used. It may be more than a linear spring constant that comes into play in these modern mooring technologies. There is also non-linear damping that can be included in the mooring/cabling, providing damping potential more generally of the mooring lines. With this response the tether remains flexible at low elongations, responding freely across the lower sea states, but smoothly changes stiffness to deliver the stiffer high load response during storm scenarios.

These modules' optional receiving and transmitting capability could also be used to remotely control various other parameters and settings on the modules themselves, or at any place in the apparatus, to respond to various wave conditions, or energy needs. As well, sensors may be located on the apparatus itself in order to relay current oceanographic and atmospheric conditions back to shore.

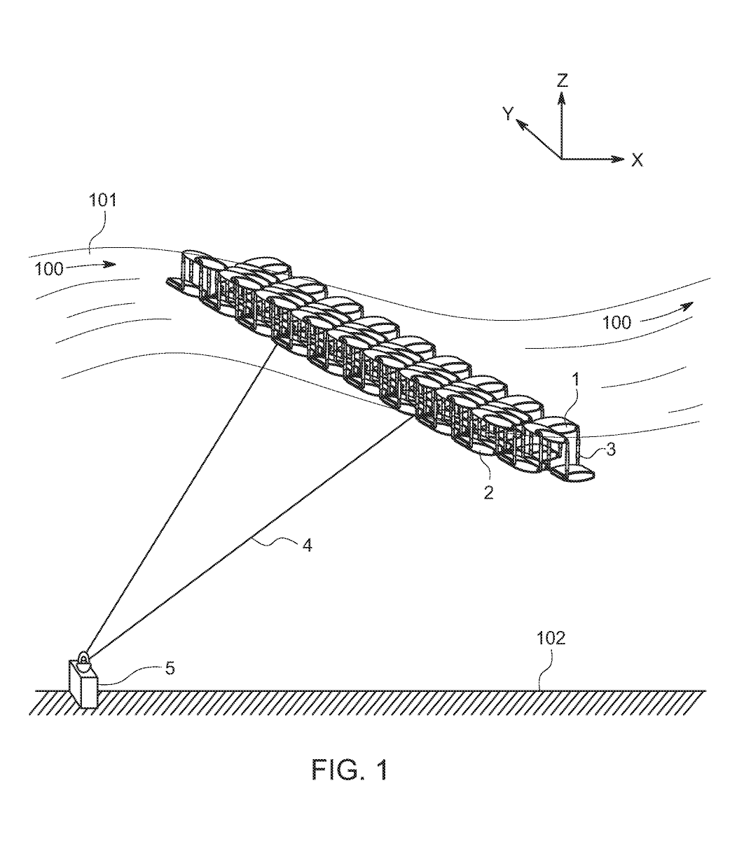

In a representative embodiment of the invention according to FIG. 1, a lattice structure is shown formed from a layer of buoyant modules 1 connected to a layer of negatively buoyant modules 2 by connecting members 3. A mooring anchor 5 attached to the sea floor is connected to the lattice structure by tether 4. In the embodiment, two components of the tether are connected to the layer of negatively buoyant modules. However as discussed in the detailed description above, many variations in the attachment of the tether to the lattice structure may be employed to advantage.

In a representative embodiment of the invention according to FIG. 2, a lattice structure is shown formed from a layer of buoyant modules 1 connected to a layer of negatively buoyant modules 2 by connecting members 3. A mooring anchor 5 attached to the sea floor is connected to the lattice structure by tether 4. In the embodiment, one component of the tether is connected to the layer of negatively buoyant modules. However as discussed in the detailed description above, many variations in the attachment of the tether to the lattice structure may be employed to advantage. A visual representation of a linear and/or non-linear spring, or spring-like element 6 is incorporated within, and/or attached to the tether. However as discussed in the detailed description above, many variations in the inclusion of the spring, or spring-like element within or attached to a particular tether may be employed to advantage.

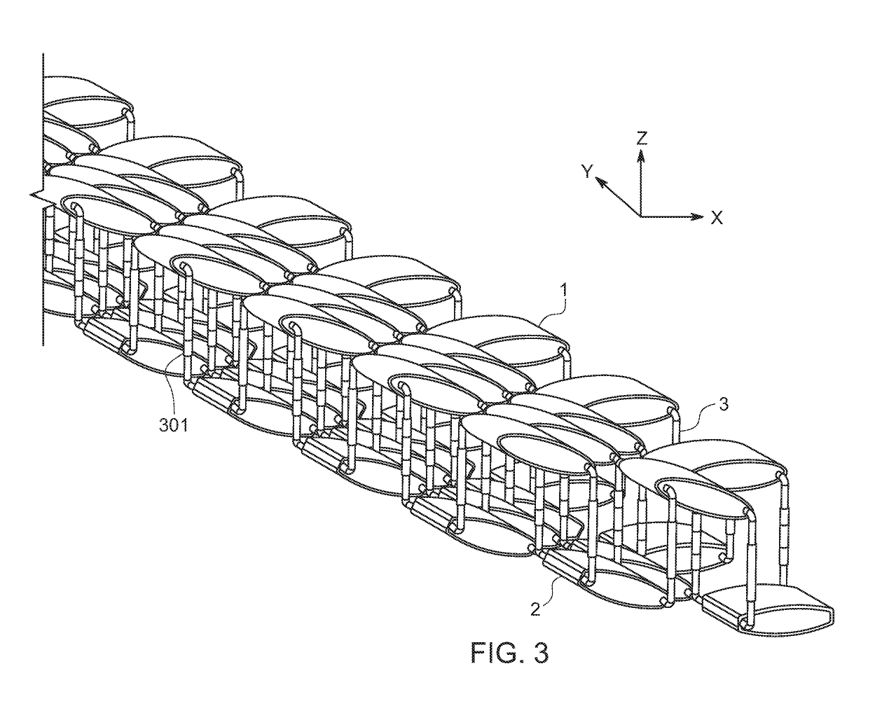

In a representative embodiment of the invention according to FIG. 3, a lattice structure is shown formed from a layer of buoyant modules 1 connected to a layer of negatively buoyant modules 2 by connecting members 3.

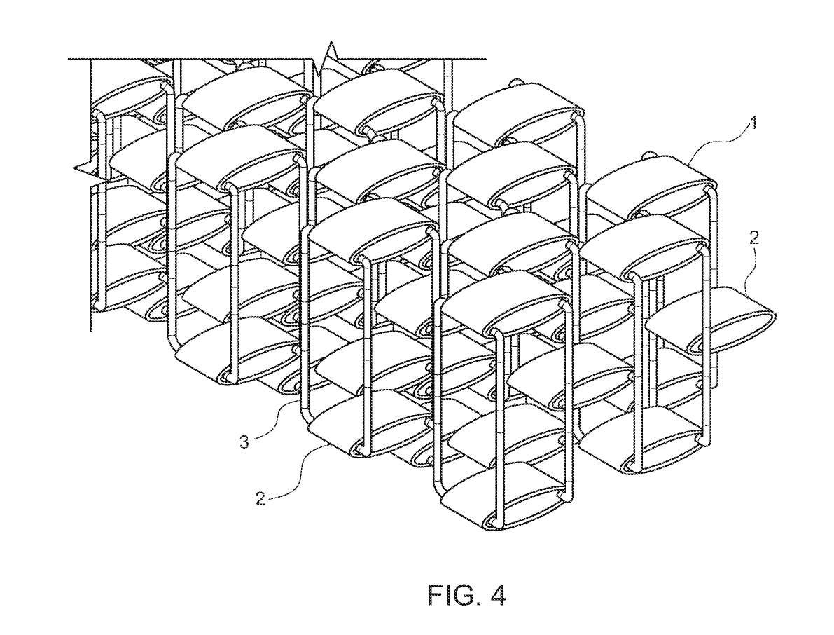

In a representative embodiment of the invention according to FIG. 4, a lattice structure is shown formed from a layer of buoyant modules 1 connected to layers of negatively buoyant modules 2 by connecting members 3, in a multi-layered arrangement.

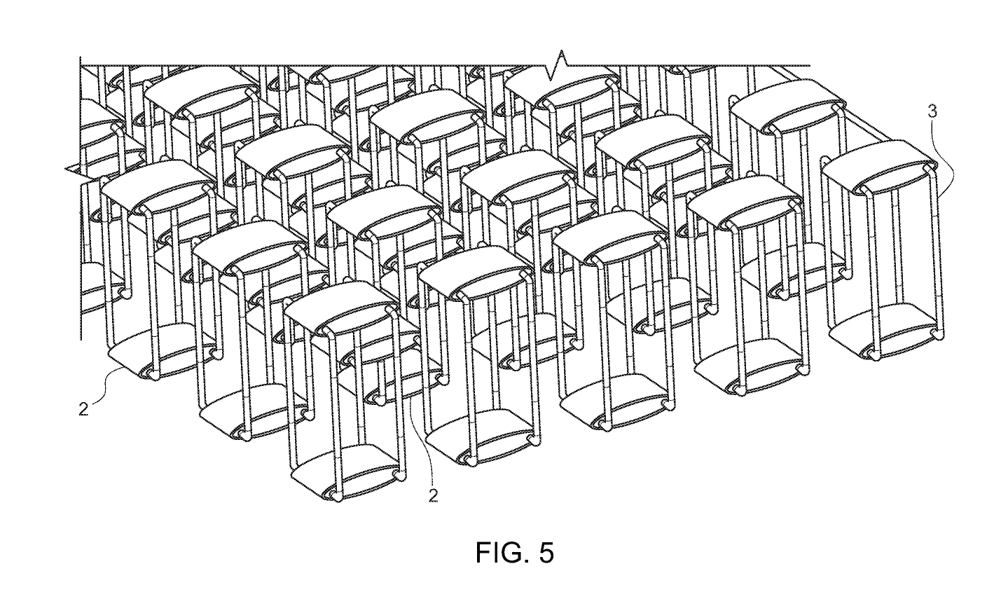

In a representative embodiment of the invention according to FIG. 5, a lattice structure is shown formed from a layer of buoyant modules 1 connected to layers of negatively buoyant modules 2 by connecting members 3, in an alternative multi-layer arrangement to FIG. 4.

Nature provides us with highly strong, and durable materials. Through manipulation, and combination of materials we have been able to utilize these inherent strengths found in nature. Steel is a material that provides profound strength, durability, and flexibility in its available uses to us. Within steel there is a particular physical configuration that allows for both its strength and ductility, among other characteristics. This configuration is found in its lattice crystal structure, steel having a BCC (body-centered cubic) configuration, which lends it some of its strength. An example of another unique lattice crystal structure found in nature can be found in Aluminum, which has a FCC (face-centered cubic) structure. These examples of crystalline configurations can lend strength and other unique qualities to the lattice of the present invention, which may be constructed with a face centered cubic, body centered cubic or other crystalline structure, connection points being the nodes or atoms of the “crystal” structure in the lattice.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Features of the invention described with reference to one embodiment may be combined with a different embodiment without departing from the scope of the invention. Likewise, a feature set forth in a dependent claim may be combined with a different independent or dependent claim(s) without departing from the scope of the invention.

I claim:

1. An apparatus for extracting power from wave motion in seawater over a sea floor, comprising:
a lattice structure comprising a plurality of modules, said plurality of modules arranged into a plurality of layers, including an upper layer of modules and a lower layer of modules, each layer extending in an x-y view, said upper layer of modules being buoyant and said lower layer of modules being negatively buoyant in said seawater, each module being attached to at least one module vertically and at least one module horizontally to form the lattice structure;
a plurality of connecting members, each said connecting member connected to adjacent modules at respective connection points, and adapted for rotation around each said respective connection point;
a mooring anchor attached to the sea floor;
a tether attached between the anchor and the lattice structure; and
a motion transducer adapted to convert rotational motion of said connecting members at said connection points relative to said modules to electrical energy; wherein
the modules of the lower layer have an extended surface area in the x-y view compared to the modules of the upper layer.

2. The apparatus according to claim 1, wherein the modules of the lower layer create an articulated platform which acts as an artificial shoaling platform to increase amplitude of an incident wave.

3. The apparatus according to claim 2, wherein the lattice structure has only two layers, an upper layer and a bottom layer, and the bottom layer has modules with extended surface area in an x-y view compared to the upper layer.

4. The apparatus according to claim 2, wherein the lattice structure has a lower layer and a plurality of upper layers and only the lower layer has modules with extended surface area in an x-y view compared to each of the upper layers.

5. An apparatus for extracting power from wave motion in seawater over a sea floor, comprising:
a lattice structure comprised of a plurality of modules, said plurality of modules arranged into a plurality of layers, including an upper layer of modules and a lower layer of modules, said upper layer of modules being buoyant and said lower layer of modules being negatively buoyant in said seawater, each module being attached to at least one module vertically and at least one module horizontally to form the lattice structure; and
a plurality of connecting members, each said connecting member connected to adjacent modules at respective connection points, and adapted for rotation at said respective connection points;
a mooring anchor attached to the sea floor;
a tether attached between the anchor and the lattice structure; and
a plurality of motion transducers each located in a respective module and adapted to convert rotational motion of said connecting members at said connection points relative to said modules to electrical energy.

6. The apparatus according to claim 5, wherein at least one connecting member comprises telescoped tubes adapted to change length.

7. The apparatus according to claim 5, further comprising an electrical cable transporting electrical current from the apparatus to land.

8. The apparatus according to claim 5, wherein the plurality of motion transducers comprises individual induction generators within a majority of the modules in the lattice.

9. The apparatus according to claim 5, wherein the tether comprises a linear and/or non-linear spring element.

10. The apparatus according to claim 5, wherein the tether is attached between the anchor and the upper layer of the lattice structure; between the anchor and the lower layer of the lattice structure; or between the anchor and the upper and lower layers of the lattice structure.

11. The apparatus according to claim 5, wherein the lattice has a front side facing oncoming waves and wherein the apparatus further comprises a second tether; and wherein
the tether is attached between the anchor and the upper layer of the lattice structure; and
the second tether is attached between the anchor and the lower layer of the lattice structure.

12. The apparatus according to claim 11, wherein the tether, the second tether, or both is provided with a linear and/or nonlinear spring element.

13. The apparatus according to claim 5, further comprising lateral connecting members connected between two modules in the upper layer, the lower layer, or both.

14. The apparatus according to claim 5, wherein the connecting members have an adjustable length adapted to adjust a vertical distance between the upper layer and the lower layer of the lattice in accordance with wave conditions of the ocean waves.

15. The apparatus according to claim 5, comprising at least one layer of modules between said upper and lower layers.

16. The apparatus according to claim 5, comprising a plurality of tethers connected to the lattice structure and to a common point on the sea floor, orienting the modules with respect to an oncoming direction of the waves.

17. The apparatus according to claim 5, wherein the plurality of modules is arranged in a crystalline pattern.

18. The apparatus according to claim 17, wherein the plurality of modules is arranged in a face centered cubic or body centered cubic crystalline pattern.

19. The apparatus according to claim 5, comprising universal joints connecting the connecting members to the modules at connection points.

20. The apparatus according to claim 5, comprising vanes on a plurality of the modules to orient the modules with respect to an incident wave.
